(19) United States
(12) Patent Application Publication
(10) Pub. No.: US 2008/0299232 A1
(43) Pub. Date: Dec. 4, 2008

(54) Cinnamon oil formulations and methods of use

(76) Inventors: Yueh Wang, Arlington Heights, IL (US); Bassam Shammo, Mundelein, IL (US); Rebecca Dickenson, Volo, IL (US); John Lopez, Gurnee, IL (US); Judith Fugiel, Lake Villa, IL (US); Linda Rehberger, Glenview, IL (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/152,796

(22) Filed: May 16, 2008

Related U.S. Application Data
(60) Provisional application No. 60/930,799, filed on May 18, 2007.

(51) Int. Cl. A01N 65/00; A01P 5/00

(52) U.S. Cl. 424/739

(57) ABSTRACT

The invention generally relates to various cinnamon oil formulations for protecting plants from nematodes and other pathogens. The invention provides specific formulations which do not require the use of chemical additives. These formulations have low phytotoxicity and low volatility. Also, methods of applying the formulations for agricultural use are disclosed.

### FIELD OF THE INVENTION

The present invention generally relates to cinnamon oil formulations for protecting plants from nematodes and other pathogens and their methods of use.

### BACKGROUND OF THE INVENTION

Plant parasitic nematodes cause serious economic damage to many agricultural crops around the world. The nematodes in this group are microscopic worms and are, in general, obligate parasites of plants. They feed mostly on the roots of host plants; however, several genera are known to parasitize above-ground parts including stems, leaves and flowers as well. Almost all the plant species of economic importance are susceptible to infection by some species of nematodes (notable exceptions are the marigolds and asparagus). For example, root knot nematodes (RKN), (Meloidogyne spp.) are capable of parasitizing more than 3,000 species of crop plants. These plants include agronomic crops, vegetables, fruits, flowering trees and shrubs. Nematodes reportedly cause crop loss of more than six billion dollars in the United States alone and more than one hundred billion dollars around the world.

The symptoms due to parasitic nematode injury vary widely depending on the plant host, the nematode species, age of the plant, geographical location and climatic and external environmental conditions. In general, an overall patchy appearance of plants in a field is considered indicative of nematode infestation. More specifically, nematode injury results in galling of the roots (abnormal swelling in the tissue due to rapid multiplication of cells in the cortical region) caused by species of root knot (Meloidogyne spp.) and cyst (Heterodera spp.) nematodes, lesions (localized, discolored areas) caused by lesion nematodes (Pratylenchus spp.), suppression of cell division resulting in stubby roots (Trichodorus spp.), growth abnormalities including crinkling or twisting of above-ground parts (Aphelenchoides spp.) and even cell necrosis (death) in some cases. Plant parasitic nematodes may be endoparasitic in nature, as in the case of the root-knot and lesion nematodes, or ectoparasitic as in the dagger nematode (Xiphinema spp.) and lance nematode (Hoplolaimus spp.). Nematodes can be vectors of plant viruses and are also known to induce disease complexes predisposing plants to infection by other plant pathogenic fungi and bacteria.

Chemical nematocides, either soil fumigants or non-fumigants, have been in use for many years and are among the few feasible options for countering nematodes. At present, the process involves repeated applications of synthetic chemicals to the ground prior to planting the crop. These chemicals are extremely toxic to organisms besides nematodes and many of them may pose serious threats to the environment. With the renewed emphasis on clean water and air by environmental groups and governmental agencies, and the detection of many of these active ingredients or the metabolites thereof in ground water and several non-target organisms, there has been serious concern as to the manufacture and/or use of these chemicals. One of the most effective, economical, and widely used nematocides, DBCP (1,2-dibromo-3-chloropropane), found in ground water has been judged to induce male sterility and possible carcinogenesis. Another widely used chemical, EDB (ethylene dibromide), has also been found in ground water.

Yet another very common insecticide-nematocide, aldicarb (2-methyl-2-(methylthio)-propionaldehyde-O-(methylcarbamoyl)oxime), has been found to be acutely toxic. Aldicarb has been found in ground water in several regions of the United States. Carbofuran (2,3-dihydro-2,2-dimethyl-7-benzofuranyl methylcarbamate) and 1,3-D (1,3-dichlorpropane), two very commonly used nematocides, are under special review by the EPA because of their avian toxicity and possible carcinogenic effects. More recently, the decision by the EPA to limit and eventually discontinue the use of the soil fumigant, methyl bromide, for agricultural purposes presents a threat to the efficiency and quality of agricultural production in the United States.

Natural isolates such as N-acetyl-D-glucosamine, which may be derived from microorganisms which are the waste products of industrial fermentation processes, have been disclosed as nematocidal in U.S. Pat. No. 5,057,141.

Biopesticides have been developed as an alternative to chemical pesticides. They are obtained by fermentation and can be used either as a crude biomass or purified. Typically, fermentations are carried out at temperatures in the range of 20-40° C. For example, submerged fermentation at 28-30° C. of Paecilomyces fumosoroues fungal isolate ATCC No. 20874 produces a fungal biomass for control of nematode infestation as disclosed in U.S. Pat. No. 5,360,607; whole fermentation broth from fermentation at 28° C. of Streptomyces thermoarchaensis NCIB 12015 is disclosed as nematocidal in U.S. Pat. No. 5,182,207; fermentation broth obtained from fermentation of Streptomyces cyaneogriseus noncyanogenus NRRL 15773 at 28° C. is effective against nematodes as disclosed in U.S. Pat. No. 5,439,934; and fermentation broth obtained by fermentation of the fungus Myrothecium verrucaria at temperatures of from 25 to 30° C. is disclosed as nematocidal in U.S. Pat. No. 5,051,255.

However, there is still a need for the development of new and effective nematocides. Plants were suggested as a source of effective pesticidal compounds as many plant essential oils exhibit antimicrobial, insecticidal, fungicidal and herbicidal activity. They have been applied as pesticides for pest, disease and weed management.

Plant essential oils which do not present any known risk to humans or to the environment are qualified for an exemption as minimum risk pesticides and are listed in 40 C.F.R. § 152.25 (b). However, high volatility, phytotoxicity and low water solubility of some oils have limited their uses in crop protection.

One plant essential oil used in agricultural applications is ProGuard® 30% Cinnamaldehyde Flowable Insecticide, Miticide and Fungicide. See U.S. Pat. Nos. 6,750,256 B1 and 6,251,951 B1. However, a downside of this commercial product is that it contains the chemical preservative o-Phenylphenol.

Nematicidal activity of plant essential oils was reported, among others, by Y. Oka (Nematology, Vol. 3 (2), pp. 159-164, 2001) and R. Pandey (J. Phytopathology 148, 501-502 (2000)). Essential oils of some plants and their components have been tested for nematicidal activity in vitro and in soil. Some plant essential oils which were determined to have nematicidal activity include essential oils of applemint (Mentha rotundifolia), caraway (Carum carvi), fennel (Foeniculum vulgare), oregano (Origanum vulgare), Syrian oregano (Origanum syriacum), and wild thyme (Coridothymus capitatus). Also, it was reported that aromatic and aliphatic aldehydes, including cinnamic aldehyde (also known as cinnamaldehyde) possess strong nematicidal activity in vitro. For example, U.S. Pat. No. 6,251,951 B1 demonstrates that cinnamaldehyde has nematicidal activity in the presence of 2% Tween 80 and 6% NaHCO₃ vehicle.

However, prior art essential oil formulations include various chemicals, such as ethanol, DMSO solvent, Tween 80 surfactants and others. One of the problems associated with the use of such chemicals is that they are often phytotoxic and limit the commercial applications of the compositions.

Accordingly, there is a need to develop a safe and easy-to-use formulation to improve the biological effectiveness of plant essential oils for agricultural applications. This formulation would have low volatility and low phytotoxicity and would not include phytotoxic chemicals.

### SUMMARY OF THE INVENTION

In one embodiment, the invention provides a formulation suitable for agricultural use comprising cinnamon oil, at least one solvent selected from the group consisting of soybean oil, methyl oleate, ethyl lactate and methyl soyate, and an emulsifier, wherein said formulation does not include an organic solvent, a surfactant or a detergent. In a preferred embodiment, the emulsifier is polyethylene sorbitol hexaoleate.

In a preferred embodiment, cinnamon oil comprises about 50% by weight of the total formulation, soybean oil comprises about 30% by weight of the total formulation, methyl oleate comprises about 10% by weight of the total formulation and polyethylene sorbitol hexaoleate comprises about 10% by weight of the total formulation.

In yet another embodiment, the invention provides a formulation suitable for agricultural use comprising cinnamon oil, soybean oil, ethyl lactate and polyethylene sorbitol hexaoleate, wherein said formulation does not include an organic solvent, a surfactant or a detergent. In a preferred embodiment, cinnamon oil comprises about 50% by weight of the total formulation.

In another embodiment, the invention provides a formulation suitable for agricultural use comprising cinnamon oil, D-Limonene and polyethylene sorbitol hexaoleate, wherein said formulation does not include an organic solvent, a surfactant or a detergent. In a preferred embodiment, cinnamon oil comprises about 50% by weight of the total formulation and D-Limonene comprises about 20% by weight of the total formulation.

In another embodiment, the invention provides a method of protecting a plant from at least one pathogen comprising applying to the plant an effective amount of the claimed formulations. In one embodiment, the pathogen may be a nematode.

In one embodiment, the plant may be a cucumber; in another embodiment, the plant may be a melon; in yet another embodiment, the plant may be a tomato.

In one embodiment, the application of the formulation is performed by spraying.

In one embodiment, the effective amount is sufficient to provide at least about 95% percent gall reduction.

In another embodiment, the effective amount is sufficient to provide at least about 90% inhibition of growth of Pythium.

In yet another embodiment, the effective amount is sufficient to provide at least about 90% inhibition of growth of Rhizoctonia.

In yet another embodiment, the effective amount is sufficient to provide at least about 90% inhibition of growth of Sclerotinia.

These representative embodiments are in no way limiting and are described solely to illustrate some aspects of the invention.

### DETAILED DESCRIPTION OF THE INVENTION

The present invention generally relates to formulations suitable for agricultural use comprising cinnamon oil, at least one solvent selected from the group consisting of soybean oil, methyl oleate, ethyl lactate and methyl soyate, and an emulsifier, wherein said formulations do not include an organic solvent, a surfactant or a detergent.

The invention further relates to methods for protecting a plant from at least one pathogen comprising applying to the plant an effective amount of the claimed formulations. The phrase “protecting a plant” means controlling the growth of pathogens, which may involve killing the pathogen and/or slowing or arresting its proliferation. Representative pathogens include, but are not limited to, nematodes, Pythium, Rhizoctonia and Sclerotinia.

While it has been previously known that plant essential oils have nematicidal activity, the known formulations contain undesirable additives, such as chemical solvents, surfactants (i.e., Tween-80) and/or detergents. Applicants have surprisingly discovered novel formulations which do not contain these undesirable additives, have low volatility, low phytotoxicity and are safe and easy to use. Applicants have discovered that natural solvents, such as soybean oil, methyl oleate, ethyl lactate and methyl soyate, can be used instead of the chemical additives to prepare essential oil formulations.

The formulation should also include an emulsifier. The preferred emulsifier is polyethylene sorbitol hexaoleate. Other suitable emulsifiers include, but are not limited to, ethoxylated soybean oil and sorbitol monooleate.

In one preferred embodiment, the cinnamon oil comprises about 50% by weight of the total formulation, soybean oil comprises about 30% by weight of the total formulation, methyl oleate comprises about 10% by weight of the total formulation and polyethylene sorbitol hexaoleate comprises about 10% by weight of the total formulation.

In yet another embodiment, the invention provides a formulation suitable for agricultural use comprising cinnamon oil, soybean oil, ethyl lactate and polyethylene sorbitol hexaoleate, wherein said formulation does not include an organic solvent, a surfactant or a detergent. In a preferred embodiment, cinnamon oil comprises about 50% by weight of the total formulation.

In yet another embodiment, the invention provides a formulation suitable for agricultural use comprising cinnamon oil, D-Limonene and polyethylene sorbitol hexaoleate, wherein said formulation does not include an organic solvent, a surfactant or a detergent. In a preferred embodiment, cinnamon oil comprises about 50% by weight of the total formulation and D-Limonene comprises about 20% by weight of the total formulation.

The methods of the present invention are carried out by applying to a plant host or to the substrate in which it is growing or is to be growing an effective amount of the claimed formulations. The phrase “effective amount” means a sufficient amount of the formulation to provide the desired effect. The amount may vary depending on the specific plant, degree of infestation, and other factors. It is well within an ordinary skill in the art to determine the necessary amount of the formulation.

The unit commonly used in the art to determine the effectiveness of the antipathogenic formulation is LC₅₀. This number represents the concentration of formulation at which 50% of pathogens die.

The formulations may be applied by spraying, pouring, dipping, in the form of concentrated liquids, solutions, suspensions, and the like. They may be applied, for example, in the form of dilute solution, in a suitable natural solvent directly to the plants either as part of an irrigation schedule or as a separate application.

In one embodiment, the effective amount is sufficient to provide at least about 95% percent gall reduction.

In another embodiment, the effective amount is sufficient to provide at least about 90% inhibition of growth of Pythium.

In yet another embodiment, the effective amount is sufficient to provide at least about 90% inhibition of growth of Rhizoctonia.

In yet another embodiment, the effective amount is sufficient to provide at least about 90% inhibition of growth of Sclerotinia.

In one embodiment of the present invention, the formulations used in accordance with the present invention include from 1 ppm to 5000 ppm of cinnamon oil; preferably, from 1 ppm to 1000 ppm of cinnamon oil, and most preferably, from 1 ppm to 500 ppm of cinnamon oil.

As used herein, all numerical values relating to amounts, weight percentages, and the like are defined as “about” or “approximately” each particular value, plus or minus 10%. Therefore, amounts within 10% of the claimed values are encompassed by the scope of the claims.

The following examples are offered by way of illustration only and not by way of limitation.

### EXAMPLE 1

### Preparation of 50% Organic Cinnamon Bark Oil Formulation

The following amounts of the ingredients were used to prepare this formulation:

50.0% by weight of the total formulation of cinnamon bark oil;

30.0% by weight of the total formulation of soybean oil;

10.0% by weight of methyl oleate; and

10.0% by weight of polyethylene sorbitol hexaoleate emulsifier.

### EXAMPLE 2

### Application of 50% Organic Cinnamon Bark Oil Formulation

### A. Nematicidal Activity

The formulation was applied against root knot nematodes (2^{nd} stage juvenile Meloidogyne incognita).

LC₅₀ (Meloidogyne incognita): 32 ppm (corresponds to 16 ppm active cinnamon oil)

### B. Greenhouse Pot Test

The formulation was used in greenhouse cucumber seedling assays.

At drench concentration of 1500 ppm, 100% gall reduction was achieved.

At drench concentration of 1000 ppm, 97% gall reduction was achieved.

### C. Volatility and Petri Dish Data

The formulation exhibited low volatility (i.e., good residual activity) after one week drenching treatment in mother soil (a mixture of eggs and nematodes).

The formulation demonstrated complete growth inhibition of Pythium (at 350 ppm), Rhizoctonia (at 375 ppm), and Sclerotinia (at 1000 ppm) in Petri dish assays.

### D. Field Data

Cucumber; 2006 Spring Trial (Moreno Valley, Calif.)

Drip Application

Results are demonstrated in Table 1.

TABLE 1

| | Gall Rating (on | | |
|---|---|---|---|
| | 0-10 scale, 10 = 100% | # Salable | # Total |
| | galled roots) | Fruit | Fruit |
| Untreated | 4.6 | 357 | 655 |
| Vydate (Chemical | 0.8 | 332 | 615 |
| Standard) | | | |
| 1000 ppm | 1.2 | 376 | 578 |
| Formulation | | | |
| 2000 ppm | 0.6 | 409 | 696 |
| Formulation | | | |
| 3000 ppm | 0.6 | 423 | 660 |
| Formulation | | | |
| 2000 ppm × 2 | 1.3 | 377 | 630 |
| Formulation | | | |
| 3000 ppm × 2 | 1.0 | 437 | 707 |
| Formulation | | | |

Cucumber, 2006 Fall Trial (Coachella Valley, Calif.)

Drip Application

Results are demonstrated in Table 2.

TABLE 2

| | Gall Rating |
|---|---|
| | (on 0-10 scale, 10 = 100% |
| | galled roots) |
| Untreated | 3.5 |
| Vydate (Chemical Standard) | 3.8 |
| Formulation, 40 gallons/A | 0.1 |
| Formulation, 20 gallons/A | 0.6 |
| Formulation, 10 gallons/A | 1 |

Tomato, 2006 Summer Trial (South Coast Research Station, Irvine, Calif.)

Treatments were applied by sprinkling a 2× concentrated aqueous application to the plots, followed by additional watering to the desired concentration.

Results are demonstrated in Table 3.

TABLE 3

| | Total Yield | Green | Red |
|---|---|---|---|
| | (kg/3 plants) | (kg/3 plants) | (kg/3 plants) |
| Untreated | 7.00 | 2.17 | 4.83 |
| Telone II (Chemical | 7.21 | 1.58 | 5.63 |
| Standard), 9 gallon/A | | | |
| Formulation, 1500 ppm | 11.82 | 3.49 | 8.32 |
| Formulation, 3000 ppm | 6.16 | 2.85 | 4.85 |

Cantaloupe (Melon) 2006 Summer Trial (South Coast Research Station, Irvine, Calif.)

Treatments were applied by sprinkling a 2× concentrated aqueous application to the plots, followed by additional watering to the desired concentration.

Results are demonstrated in Table 4.

TABLE 4

| | Fruit | Number of | Pounds of |
|---|---|---|---|
| | Size | Fruit/Plant | Fruit/Plant |
| Untreated | 1.82 | 8.11 | 15.35 |
| Telone II (Chemical | 2.08 | 12.2 | 25.68 |
| Standard), 9 gallon/A | | | |
| Formulation, 1500 rpm | 1.92 | 15.25 | 22.33 |

These data demonstrate that the formulation was safe to apply to young cucumber seedlings up to 3,000 ppm concentration.

### EXAMPLE 3

### Cinnamon Oil Formulations

A. Cinnamon Oil and Ethyl Lactate Formulation

Preparation

The following amounts of the ingredients were used to prepare this formulation:

50.0% by weight of the total formulation of cinnamon oil;

20.0% by weight of the total formulation of soybean oil;

20.0% by weight of ethyl lactate; and

10.0% by weight of polyethylene sorbitol hexaoleate.

Nematicidal Activity

The formulation was applied against root knot nematodes (2^{nd} stage juvenile Meloidogyne incognita).

LC₅₀ (Meloidogyne incognita): 29 ppm

Greenhouse Pot Test

The formulation was used in greenhouse cucumber seedling assays.

At drench concentration of 1000 ppm, 90% gall reduction was achieved.

At drench concentration of 500 ppm, 50% gall reduction was achieved.

B. Cinnamon Oil and D-Limonene Formulation

Preparation

The following amounts of the ingredients were used to prepare this formulation:

50.0% by weight of the total formulation of cinnamon oil;

20.0% by weight of the total formulation of D-Limonene; and

10.0% by weight of polyethylene sorbitol hexaoleate.

Nematicidal Activity

The formulation was applied against root knot nematodes (2^{nd} stage juvenile Meloidogyne incognita).

LC₅₀ (Meloidogyne incognita): 25 ppm

Greenhouse Pot Test

The formulation was used in greenhouse cucumber seedling assays.

At drench concentration of 1500 ppm, 80% gall reduction was achieved.

At drench concentration of 500 ppm, 70% gall reduction was achieved.

1. A formulation suitable for agricultural use comprising cinnamon oil, at least one solvent selected from the group consisting of soybean oil, methyl oleate, ethyl lactate and methyl soyate, and an emulsifier, wherein said formulation does not include an organic solvent, a surfactant or a detergent.

2. A formulation suitable for agricultural use comprising cinnamon oil, soybean oil, methyl oleate and an emulsifier, wherein said formulation does not include an organic solvent, a surfactant or a detergent.

3. The formulation of claim 1, wherein said emulsifier is polyethylene sorbitol hexaoleate.

4. The formulation of claim 3, wherein cinnamon oil comprises about 50% by weight of the total formulation, soybean oil comprises about 30% by weight of the total formulation, methyl oleate comprises about 10% by weight of the total formulation, and polyethylene sorbitol hexaoleate comprises about 10% by weight of the total formulation.

5. The formulation of claim 3, wherein cinnamon oil comprises about 50% by weight of the total formulation, the soybean oil comprises about 20% by weight of the total formulation, ethyl lactate comprises about 20% by weight of the total formulation, and polyethylene sorbitol hexaoleate comprises about 10% by weight of the total formulation.

6. The formulation of claim 3, which further comprises D-Limonene, and wherein cinnamon oil comprises about 50% by weight of the total formulation, D-Limonene comprises about 20% by weight of the total formulation, and polyethylene sorbitol hexaoleate comprises about 10% by weight of the total formulation.

7. A method of protecting a plant from at least one pathogen comprising applying to the plant an effective amount of the formulation of claim 1.

8. The method of claim 7, wherein said pathogen is a nematode.

9. The method of claim 5, wherein said applying is by drenching.

10. The method of claim 7, wherein said effective amount is sufficient to provide at least about 95% percent gall reduction.
